(19) United States
(12) Patent Application Publication
(10) Pub. No.: US 2007/0251100 A1
(43) Pub. Date: Nov. 1, 2007

(54) Thread cutting apparatus

(76) Inventor: Dani Fisk, Wrightwood, CA (US)

Correspondence Address: LAW OFFICE OF J. CURTIS EDMONDSON, P.O. BOX 571, CLAREMONT, CA, 91711, US

(21) Appl. No.: 11/413,879

(22) Filed: Apr. 27, 2006

(51) Int. Cl. B26B 13/00

(52) U.S. Cl. 30/253

(57) ABSTRACT

A thread cutting apparatus that is held between the thumb and forefinger used to cut and remove stitched seams in fabric and the like combining the feature of traditional tweezers and scissors, so that only one tool is needed for the removal process of stitches.

### BACKGROUND

1. Field of the Invention

This invention relates to instruments, more specifically to an instrument for the cutting and removing of stitches from a lockstitch seam made by a sewing machine. In the process of joining various types of fabrics occasionally, there is a need to remove or modify the stitched seam.

2. Background

Removing or modifying a stiched seam traditionally this required the use of at least two instruments. One instrument was used to cut the thread or stitch at two points, both extremities of the seam that was to be removed; typically, a scissor-like device was used. Once the length of the seam, approximately ½″ comprising of 6 or 7 stitches, was severed a second instrument, usually a tweezers-like device or forceps was used to grasp one end of the thread and remove it from the joined fabric by pulling it along the length of the stitch.

The U.S. Pat. No. 6,608,698 issued to Mindheim (1950) describesa a tweezers configuration with cutting blades positioned at right angles to the arms of the tweezers. The thread is grasped in points, as operator continues to squeeze, the blades come together and cut thread. Due to the position of the blades being above the grasping edge the tweezers must be inserted deep into the fabric.

The U.S. Pat. No. 2,998,649 to Miller et al. (1961) describes a pair of tweezers with a single inclined plate with knife edge mounted at right angles on inside surface of lower arm. When tweezers is squeezed thread plate indexes into slot cut into inside surface of upper arm. Thread on incline will be cut as place engages slot.

The U.S. Pat. No. 3,266,493 to Cummings (1966) depicts a combination of tweezers and scissors. The device can be rotated by the fingers to position either the scissors or gripping points to cut and pluck the stitches.

U.S. Pat. No. 4,052,979 to Tuthill et al. (1977) demonstrates a disposable suture cutter formed of tweezers that are held between the fingers and thumb. The tweezers have opposed free ends with one of the free ends shaped so that it can be inserted under a suture with a suture retaining groove for holding the suture. A cutting blade is attached to the other free end of the tweezers. The cutting blade is attached to the other free end of the tweezers. The cutting blade end of the tweezers allows for movement traversely and downwardly to cut the suture being held by the retaining groove.

U.S. Pat. No. 5,015,252 to Jones (1991) depicts a surgical forceps device with inward facing points at the end of spaced apart arms that are specifically designed to hold the sides of a surgical incision together during suturing. The handle of the forceps provides for a knife blade that is partially exposed by a notch in the handle.

U.S. Pat. No. 5,023,997 to Salvi (1991) demonstrates a pair of tweezers enables cutting by pointing inward two sharp metallic ends, perpendicular to the two legs surfaces of the tweezers. It is also equipped with a removable actuating lever made of one bent piece of metal.

U.S. Pat. No. D493,255 to Lamagna (2004) illustrates a pair of tweezers that do have a sharpened blade for cutting threads.

U.S. Patent Publication 2005/02622704 (2005) depicts a seam ripper that cuts threads via a radial motion.

### SUMMARY OF THE INVENTION

The present invention discloses an improved thread cutting apparatus useful in the removal of stitched connections, comprised of a pair of spaced apart arms joined at one end to form a pair of tweezers or forceps, which can be held between the thumb and forefinger. When pressure is applied by the clamping action of the thumb and forefinger, the distal ends of the spaced apart arms will make contact, so as to be able to grasp items, such as thread or sutures.

The material used for the device has sufficient resiliency to allow for resistance to deformation caused by the squeezing action of the thumb and forefinger and will return to its original position after manipulation.

The two arms are joined near their proximal ends and have a hole penetrating through the assembly of sufficient diameter to enable a cord, wire or lanyard to pass through for the purpose of hanging the implement around the neck or to secure to one's wrist.

The distal ends of the spaced apart arms taper and terminate into sharp points and sections of the arms nearest the distal ends are beveled on each side to form knife-like edges, but as few as one knife-like edge is contemplated. However, by having two knife-like edges or blades, one on each arm, on the same side of the tweezers assembly one unit can be rotated and used by right or left-handed users.

Because the device may be used by either right handed or left-handed persons it may have selective marked so that the user can easily properly orient the device to perform the stitch removal, such as different colored lines on the arms visible when the device is in the proper orientation for the dexterity of the user.

Removing of a stitched seam requires three steps. The first is to insert or thrust the pointed edge of the device between the stitch and the fabric that will cause the thread to be in contact with the blade or knife-like edge of tweezers. As the pointed tip drives further between the stitches it acts as a wedge stretching the thread and eventually cutting it along the interface between it and the blade or sharp knife-like edge.

The second step is to repeat the previous action on a different point on the stitched seam, thus forming the desired length of stitch to be removed. Once the stitch is severed in these two places, the third step requires grasping either loose thread end with the distal point of the tweezers and removing the thread.

### BRIEF DESCRIPTION OF THE DRAWINGS.

Taking the following specifications in conjunction with the accompanying drawings will cause the invention to be better understood regarding these and other features and advantages. The specifications reference the annexed drawings wherein:

FIG. 1 is an isometric view of the thread cutting apparatus; and

FIG. 2 is a top plan view of the thread cutting apparatus; and

FIG. 3 is an isometric view of the thread cutting apparatus showing the manner of cutting and removing a stitched seam.

### DETAILED DESCRIPTION

1. Overview

The preferred embodiment or “Tweezor” combines the functionality of these two separate tools conveniently into one instrument, so that the cutting action and the grasping and pulling action can be performed by a single instrument, which alleviates the need for the operator to switch tools and so makes the stitch removal process more efficient.

Moreover, the preferred embodiment also provides for a means of hanging the device around one's neck, as is customary for long arm quilters. More succinctly, the preferred embodiment comprises a traditional style pair of tweezers with sharpened side edges, which can either pluck or cut the seam by varying the orientation and movement of the instrument.

The device is particularity useful for commercial long arm quilters who need to remove yards of stitching as quickly as possible. In addition, because the stitches are held in bating and are cushioned rather that lie on flat fabric as in a garment seam this cushion allows the point of the device to be inserted without difficulty.

Additionally, it is foreseeable that this invention can be utilized for cutting and removing a variety of thread-like connections, such as various machine stitches, hand stitches, woven material, fine wire, fishing line or surgical sutures.

While describing the invention and its embodiments, various terms will be used for the sake of clarity. These terms are intended to not only include the recited embodiments, but also all equivalents that perform substantially the same function, in substantially the same manner to achieve the same result.

2. Description of the Drawings

A preferred embodiment of the present invention discloses an improved tweezers or thread cutting apparatus.

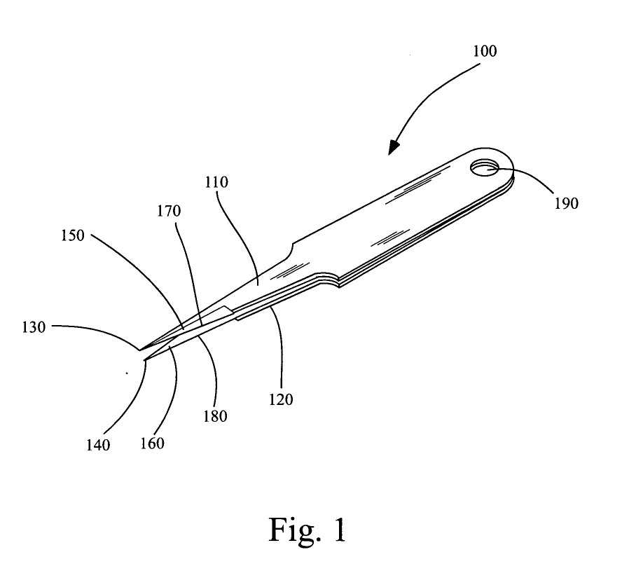

As shown in FIG. 1 and indicted generally by the reference number 100 is comprised of a pair of spaced apart arms 110 and 120 joined at the assembly's end 200 to form a pair of tweezers or forceps, which can be held between the thumb and forefinger. The spaced apart arms 110 and 120 are generally rectangular in cross section.

The assembly is preferably made of a metallic material that has sufficient resiliency to allow for resistance to deformation caused by the squeezing action of the thumb and forefinger, but then again, composite or plastic materials may also be contemplated, so long as this material can resist deformation and return to its original position after manipulation. This material should be suitable to be sharpened to a knife-edge or to allow for the insertion of a sharp blade edge such as a razor blade.

In the preferred embodiment, the two arms 110 and 120 are joined near their end 200 by fusion welding with a hole 190 penetrating through the thread cutting apparatus 100 near the assembly's end 200 of sufficient diameter to enable a cord, wire or lanyard to pass through for the purpose of hanging the implement around the neck or to secure to one's wrist.

The distal ends of spaced apart arms 110 and 120 taper and terminate into sharp points 130 and 140. The spaced apart arms 110 and 120 are beveled on each side to form knife-like edges 150 and 160 that extend from the sharp points 130 and 140 towards the assembly's end 200.

In the preferred embodiment, knife-like edges 150 and 160 occur only on one side of the thread cutting apparatus 100 and then for a length less than the majority of each of the arms 110 and 120.

In other embodiments, it has been contemplated to have as few as one knife-like edge 150, but by having knife-like edges 150 and 160, one on each arm 110 and 120 on the same side of the thread cutting apparatus 100 allows for one unit to be rotated and used by right or left-handed users.

It is also contemplated that by sharpening only one side of the device helps protect the user from inadvertent injury and also adds to the strength of the thread cutting apparatus 100 by maximizing the amount of material is on each spaced apart arms 110 and 120.

The preferred embodiment contemplates the knife-like edges having a length of 0.5 inches running from point of the arms.

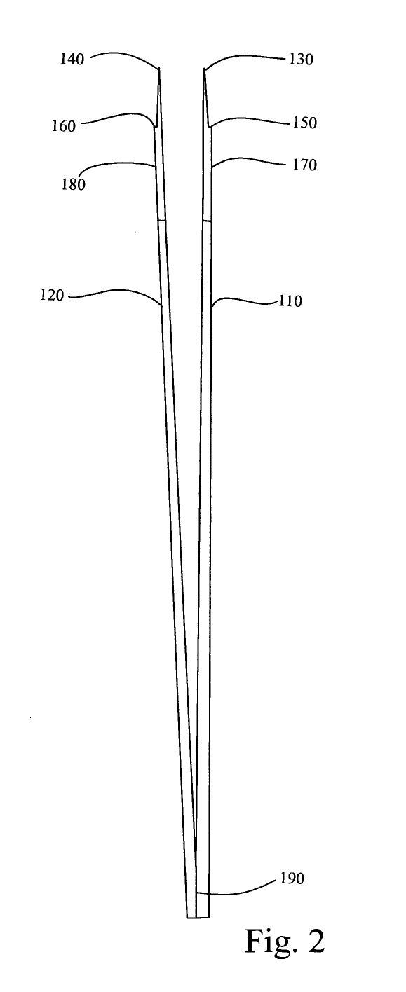

Now referring to FIG. 2. FIG. 2 depicts the thread cutting apparatus in a top plan view and illustrates the use of orientation guides 170 and 180. Because the device may be used by either right handed or left-handed persons it is important for the user to quickly discern whether or not he has the device properly orientated to perform the stitch removal. In one embodiment, the orientation guide 170 is a thin blue line that would be visible when the device is in the proper orientation for a left-handed person while the other orientation guide 180 is a thin red line that would be visible when the device is orientated for proper right-handed use. This is for illustrative purposes and it is obvious that different colors may be used or different symbols or letters to notify the user of the proper orientation of the device.

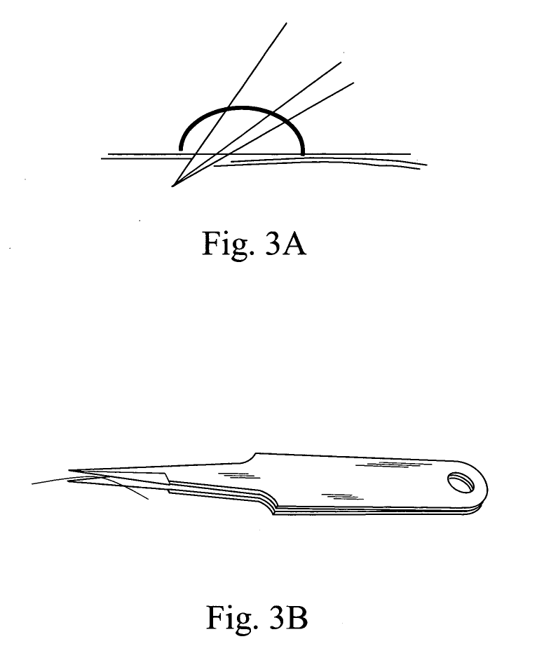

Now referring to FIG. 3. As shown in FIG. 3 a thread cutting apparatus 100 in an isometric view showing the manner of cutting and removing a stitched seam.

In one embodiment where the removal of machine-sewn stitches is desired the optimum width of each arm 110 and 120 at the mid point of the blade or knife-like edge 150 and 160 should be about 1/12″ which corresponds to the typical spacing between machine sewn stitch. The sharp points 130 and 140 should be tapered to a point and be thin enough to be easily inserted under a stitch without damaging the underlying material or fabric. Once a sharp point 130 or 140 is further inserted under a stitch the corresponding knife-like edge either 150 or 160 will severe at least one side of the stitch by a wedge-like action.

The manner of using the device is similar to that of a traditional tweezers, which are held between the forefinger and thumb. When the device is held in the right hand, the arm 120 nearest the stitches (the lower arm) will have the knife-like edge 160 on the left side and the orientation guide 180 possible a thin red line on the flat surface of the arm 120 will be visible to the operator. The pointed end of the arm or sharp point 140 is inserted under single stitch of the line of stitching to be removed, taking care not to pierce the fabric. As the sharp point 140 is pushed further under the stitch loop, the two ends of the thread will eventually be stretched over the taper of the arm and the knife-like edge 160 will cut the thread to the left. The thread cutting apparatus is then withdrawn and the operation is repeated at a point 3 to 5 stitches away from the severed thread and the process repeated. Either sharp point 130 or 140 is then inserted under the stitch midway along the cut seam which is pinched or grasped with both pointed ends 130 and 140 of the Tweezor and plucked to release the thread from the lockstitches formed with the bottom thread.

When the device is held in the left hand, the arm 130 nearest the stitches (the lower arm) will have the knife-like edge 150 on the right side and orientation guide 170 possibly a thin blue line on the flat surface of the arm 110 will be visible to the operator. All further operations remain the same.

The term “thread” should not be limited to threads used to join pieces of cloth. The term “thread” can also refer to any material with thread like properties, such as a suture, which is used to join materials (e.g. skin in surgical applications).

The invention has been described in terms of the preferred embodiment. One skilled in the art will recognize that it would be possible to construct the elements of the present invention from a variety of means and to modify the placement of the components in a variety of ways.

While the embodiments of the invention have been described in detail and shown in the accompanying drawings, it will be evident that various further modifications are possible without departing from the scope of the invention as set forth in the following claims.

I claim:

1. A device for cutting and removing stitched seams which comprises:
a pair of flat arms; wherein
said first flat arm having a first generally rectangular end and a second pointed end, an inner surface, an outer surface, an upper portion, and a bottom portion;
and a second flat arm having a first generally rectangular end and a second pointed end, an inner surface, an outer surface, an upper portion, and a bottom portion; and
wherein the inner surface of the first generally rectangular end of the first flat arm is joined with the inner surface of the first generally rectangular end of the second flat arm, and
wherein said inner surface of second pointed end of said first flat arm is spaced apart from the inner surface of second pointed end of said second flat arm; and
wherein the upper portion of the second pointed end of the first flat arm is sharpened.

2. The device of claim 1, wherein the upper portion of the second pointed end of the second flat arm is sharpened.

3. The device of claim 1, wherein the spacing between the second pointed end of the first flat arm and the second pointed end of the second flat arm is approximately 1/12″.

4. The device of claim 1, wherein the length of the flat arms are approximately 4 inches.

5. The device of claim 1, wherein the width of the arms is approximately 0.3725 inches.

6. The device of claim 1, wherein a void is present near the first generally rectangular end of the first flat arm and the first generally rectangular end of the second flat arm such that the void is mutually aligned and of such dimensions to allow for the insertion of a chord or string.

7. The device of claim 1, wherein the device is fabricated of a relatively elastic material such as steel or rigid plastic.

8. The device of claim 1, wherein the first flat arm has a different mark than the second flat arm for orientation purposes.

9. The device of claim 2, wherein the first flat arm has a red thin red line and the second flat arm has a thin blue line to proximate to the knife-like edges.

10. The method of removing a length thread from fabric, said method consisting of:
selecting a first thread section; and
inserting a sharpened point underneath the first section; and
slicing the first thread section with the sharpened point of thread cutting apparatus; and
selecting a second thread section; and
inserting a sharpened point of a thread cutting apparatus underneath the second stitch; and
slicing the second thread section with the sharpened point of thread cutting apparatus; and
pulling the length of thread between the first thread section and the second thread section with the grasping end of the thread cutting apparatus;
such that the length of thread is removed from the fabric.
